(19) United States
(12) Patent Application Publication
(10) Pub. No.: US 2026/0040306 A1
(43) Pub. Date: Feb. 5, 2026

(54) SYSTEM AND SCHEME ON PAGING OPERATION WITH TIMING REFERENCE

(71) Applicant: Huawei Technologies Co., Ltd., Shenzhen (CN)

(72) Inventors: Liqing Zhang, Ottawa (CA); Hao Tang, Ottawa (CA); Jianglei Ma, Ottawa (CA)

(21) Appl. No.: 19/355,731

(22) Filed: Oct. 10, 2025

Related U.S. Application Data
(63) Continuation of application No. PCT/CN2023/099790, filed on Jun. 13, 2023.
(60) Provisional application No. 63/458,453, filed on Apr. 11, 2023.

(51) Int. Cl. H04W 72/1273; H04W 72/1268

(52) U.S. Cl. CPC H04W 72/1273; H04W 72/1268

(57) ABSTRACT

An example method includes receiving, at a reception time, a downlink message, and transmitting a uplink signal with an uplink signal timing. The uplink signal timing is based on a difference between the reception time and a transmission time determined for the downlink message.

### CROSS-REFERENCE TO RELATED APPLICATIONS

This application is a continuation of International Application No. PCT/CN2023/099790, filed on Jun. 13, 2023, which claims priority to U.S. Patent Application No. 63/458,453, filed on Apr. 11, 2023, both of which are hereby incorporated by reference in their entireties.

### TECHNICAL FIELD

The present disclosure relates, generally, to wireless communication networks and, in particular embodiments, to paging operations in such networks and, in further particular embodiments, to use of a timing reference in such paging operations.

### BACKGROUND

Paging operations carried out in wireless communication networks may be understood to usually involve cell-specific signaling or group-specific signaling intended for receipt by User Equipments (UEs). Some of the UEs may be in a connected state or mode. Other UEs may be in a non-connected state or mode. UEs are known to enter into a non-connected state or mode, such as the known “Inactive state” or the known “Idle state,” for power saving purposes. It may be shown that one or more power saving modes are involved in a sleep cycle, or a Discontinuous Reception (DRX) cycle, of a UE. It is known that a paging operation may be used, by a base station, to provide a notification to a UE. The notification may relate to an event, a demand for a downlink (DL) traffic (control or data) transmission and/or a demand for an uplink (UL) traffic (control or data) transmission.

To receive paging and DL traffic and to perform UL transmission, it is preferred that a given UE has downlink (DL) synchronization and uplink (UL) synchronization. DL synchronization may be shown to relate to carrier frequency offset (CFO) compensation, automatic gain control (AGC), time tracking and frequency tracking. UL synchronization may be shown to relate to UL traffic transmissions.

To achieve DL synchronization, the given UE may monitor and detect one or more synchronization signal blocks (SSBs). SSBs are known to include a primary synchronization signal, a secondary synchronization signal and a physical broadcast channel. The given UE may also use tracking reference signal (TRS) for further synchronization.

To achieve UL synchronization, a propagation delay between the given UE and the base station may be obtained or estimated such that a timing advance (TA) may be obtained before a planned UL traffic transmission. The propagation delay is usually a function of the location of the given UE within a cell served by the base station. The propagation delay may also be a function of a mobility of the given UE. The propagation delay may also be a function of features of a wireless environment in which the given UE is functioning or communicating with the base station. A legacy network may employ a measurement of a time for round-trip signaling (two-way signals, i.e., DL and UL) or perform a UL transmission to obtain timing adjustment (TA) at the base station, which sends the TA information to the UE to allow for UL synchronization. In other words, obtaining a TA allowing for the UL synchronization, at the UE, may require assistance in the form of a timing measurement (e.g., a comparison to a frame, a slot, or a symbol boundary in a cell) at the base station.

### SUMMARY

Aspects of the present application relate to simplifying signaling and reducing latency associated with paging with DL traffic and UL traffic communication. A paging procedure features an absolute timing indication and/or calibration information. In paging operations, a timing reference may be used to improve an estimation of propagation delay.

Known propagation delay estimation strategies involve obtaining a timing advance estimated at an entity (e.g., a base station) that is distinct from the user equipment. Such known propagation delay estimation strategies may be referenced as round-trip, or two-way, measurement strategies, or at least a UL transmission to and timing adjustment measurement at the entity (e.g., the base station), which has to send the timing adjustment information to the UE via a DL transmission.

Aspects of the present application relate to a one-way measurement strategy. One-way measurement strategies may be shown to benefit from timing reference information. Accordingly, aspects of the present application relate to providing, to a user equipment, timing reference information. Conveniently, it may be shown that aspects of the present application allow for faster and more accurate downlink synchronization and uplink synchronization.

According to an aspect of the present disclosure, there is provided a method. The method includes receiving, at a reception time, a downlink message and transmitting an uplink signal with an uplink signal timing, the uplink signal timing based on a difference between the reception time and a transmission time determined for the downlink message.

According to an aspect of the present disclosure, there is provided an apparatus. The apparatus includes at least one processor coupled to a memory storing computer-readable instructions, caused, by executing the computer-readable instructions, to receive, at a reception time, a downlink message and transmit an uplink signal with an uplink signal timing, the uplink signal timing based on a difference between the reception time and a transmission time determined for the downlink message.

According to an aspect of the present disclosure, there is provided a non-volatile computer-readable medium storing instructions. The instructions, when executed by a processor, cause the processor to receive, at a reception time, a downlink message and transmit an uplink signal with an uplink signal timing, the uplink signal timing based on a difference between the reception time and a transmission time determined for the downlink message.

According to an aspect of the present disclosure, there is provided a method. The method includes receiving, a reference signal (RS) for downlink synchronization and performing, based on an indication carried in the RS, at least one of following operations: receiving a paging message; and receiving updated system information.

According to an aspect of the present disclosure, there is provided an apparatus. The apparatus includes at least one processor coupled to a memory storing computer-readable instructions, caused, by executing the computer-readable instructions, to receive, a reference signal (RS) for downlink synchronization and perform, based on an indication carried in the RS, at least one of following operations: receiving a paging message; and receiving updated system information (SI).

According to an aspect of the present disclosure, there is provided a non-volatile/non-transitory computer-readable medium storing instructions. The instructions, when executed by a processor, cause the processor to receive, a reference signal (RS) for downlink synchronization and perform, based on an indication carried in the RS, at least one of following operations: receiving a paging message; and receiving updated system information (SI).

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates, in a traffic flow diagram, procedures that may be carried out in a legacy network before and after paging messages;

FIG. 7A illustrates, in a traffic flow diagram, procedures that may be carried out by an example base station (BS) and an example user equipment (UE) that may be understood to be in power mode that includes a sleep cycle or a DRX cycle, in accordance with aspects of the present application;

FIG. 7B illustrates, in a traffic flow diagram, procedures that may be carried out by an example base station (BS) and an example user equipment (UE) that may be understood to be in an active mode or a power saving mode, in accordance with aspects of the present application;

FIG. 8 illustrates a timeline of activity for a UE, in accordance with aspects of the present application;

FIG. 9 illustrates a timeline of activity for a UE, in accordance with aspects of the present application; and

FIG. 10 illustrates a table summarizing configuration of the various indications discussed as being carried by a paging reference signal, in accordance with aspects of the present application.

### DETAILED DESCRIPTION OF THE ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

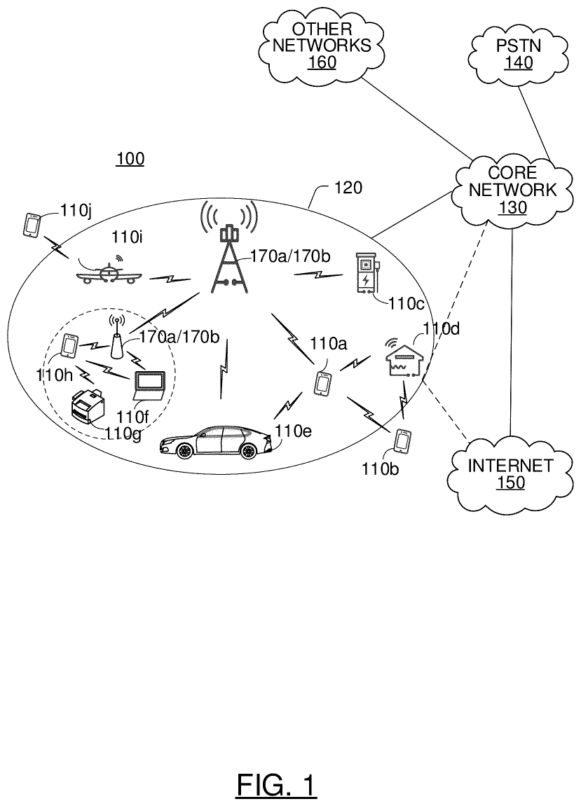

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

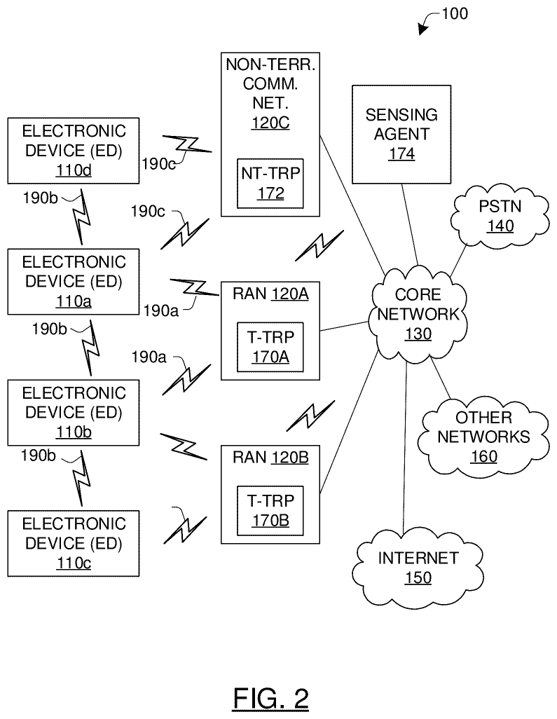

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA) or Direct Fourier Transform spread OFDMA (DFT-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

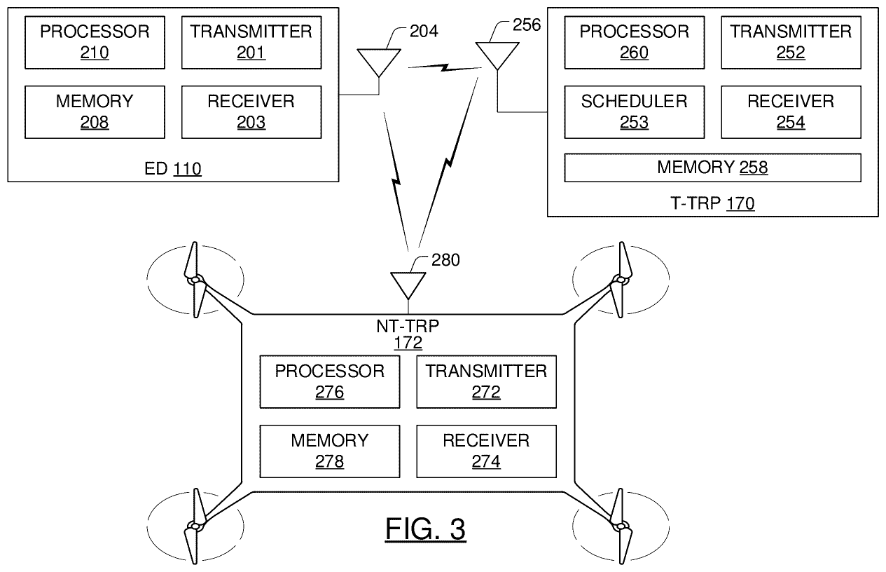

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, wearable devices such as a watch, head mounted equipment, a pair of glasses, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a Central Processing Unit (CPU), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a CPU, a GPU or an ASIC.

Notably, the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a CPU, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

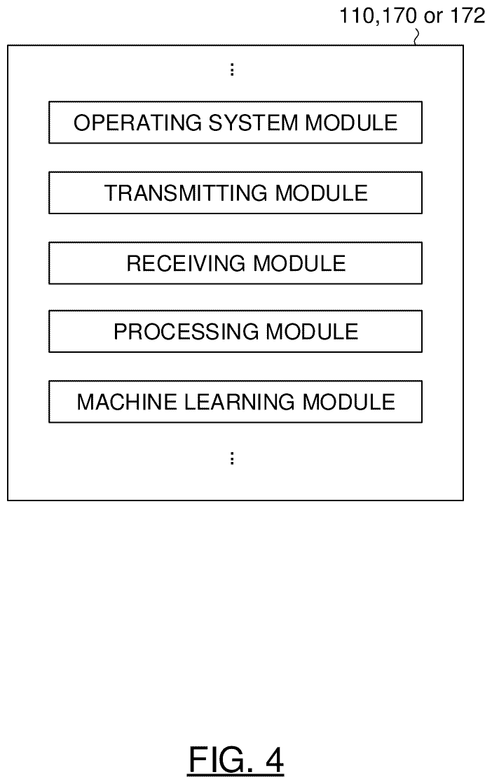

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a CPU, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Direct Fourier Transform spread OFDM (DFT-OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; OFDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0.5%.

The carrier, the BWP or the occupied bandwidth may be signaled by a network device (e.g., by a base station 170) dynamically, e.g., in physical layer control signaling such as the known downlink control channel (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

UE position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

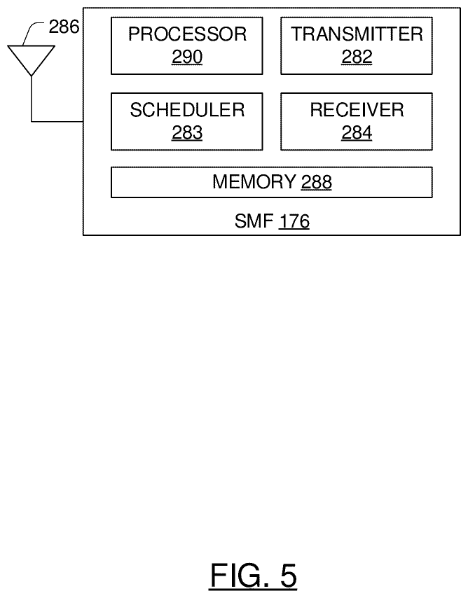

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-HWC side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f−f_{chirp0}=α(t−t_{chirp0}), where α=f_{chirp1}−f_{chirp0}/t_{chirp1}−t_{chirp0} is defined as the chirp slope. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπαt}^{²} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectral efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectral efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or a SSB resource identifier, or a sounding reference signal (SRS) resource identifier, or other reference signal resource identifier.

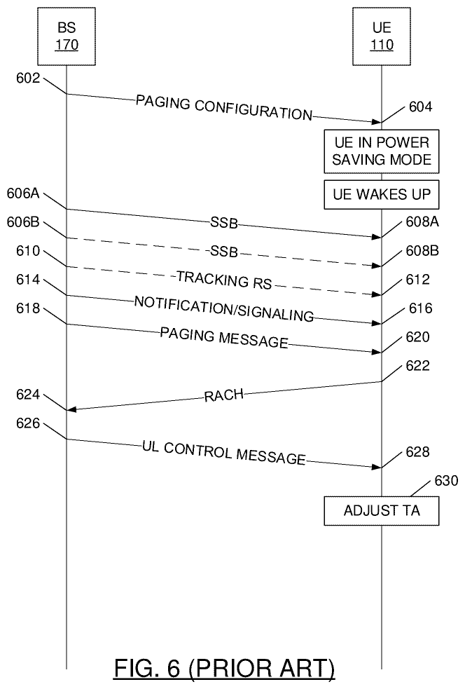

On the basis of DL synchronization preferences and UL synchronization preferences, DL traffic transmissions and UL traffic (e.g., control or data) transmissions, for a given legacy network, may occur as illustrated in FIG. 6. FIG. 6 illustrates, in a traffic flow diagram, procedures that may be carried out in the given legacy network before and after paging messages.

The known exchange of traffic illustrated in FIG. 6 may be understood to apply for those scenarios in which the UE 110 has lost DL synchronization and/or UL synchronization.

The known paging and synchronization procedure of FIG. 6 commences with the BS 170 transmitting (step 602), to the UE 110, a paging configuration. The BS 170 may transmit (step 602) the paging configuration, for example, via SSBs or/and radio resource control (RRC). Subsequent to receiving (step 604) the paging configuration, the UE 110 may enter a power saving mode. The power saving mode may be implemented, by the UE 110, as a sleep portion of a DRX cycle.

The BS 170 may, at some point, transmit (step 606A, step 606B) one or more SSBs (two SSBs are illustrated in FIG. 6, many more than two SSBs may be transmitted) to accommodate DL synchronization. The UE 110, upon waking up, may monitor and detect (step 608A, step 608B) the one or more SSBs to accommodate the DL synchronization.

The UE 110 may process the received (step 608A, step 608B) the SSBs to obtain DL synchronization. Obtaining DL synchronization may be understood to relate to aligning frame structures of DL communications.

Subsequent to transmitting (step 606A, step 606B) the SSBs, the BS 170 may (optionally) transmit (step 610) a tracking reference signal (RS). The UE may monitor and detect (step 612) the tracking RS. By processing measurements of the received (step 612) tracking RS, the UE 110 may enhance the DL synchronization that may already be in place based on the UE 110 having processed the received (step 608A, step 608B) SSBs.

The BS 170 may next transmit (step 614) a paging notification. Alternatively, the BS 170 may transmit (step 614) a DL notification. Further alternatively, the BS 170 may transmit (step 614) paging control signaling. The paging control signaling may take the form of group-common downlink control information (DCI) signaling. Alternatively, the paging control signaling may take the form of UE-specific DCI signaling. The paging notification, the DL notification or the paging control signaling may be transmitted (step 614) in a DL control channel, such as a physical downlink control channel (PDCCH).

Upon receiving (step 616) the notification/signaling, the UE 110 may determine that the paging notification or the DL notification includes, for several non-limiting examples, a notification of an event (such as a risk warning) or multiple events, a notification of a coming DL data transmission or a notification of a paging skipping notice. The UE 110 may determine that the paging notification or the DL notification includes a schedule that specifies time resources and frequency resources for transmission of a paging message or a data message, if applicable.

The BS 170 may then transmit (step 618), to a plurality of paged UEs including the UE 110 of FIG. 6, a paging message. The BS 170 may transmit (step 618) the paging message in a DL data channel, such as a physical downlink shared channel (PDSCH). The paging message may include a paging UE identification (ID) for each paged UE. Each paged UE 110 may monitor to detect (step 620) a paging message.

Responsive to the UE 110 determining that UL synchronization has been lost or is unknown, the UE 110 may initiate (step 622) a random access channel (RACH) procedure (either a 2-step RACH or a 4-step RACH) to obtain a TA estimation from the BS 170.

Responsive to receiving (step 624) a (first) UL message in the RACH, the BS 170 may be able to estimate a timing adjustment for the UE 110 and transmit (step 626), to the UE 110, UL control information, via a DL message. The UL control information may include the TA information, such that, upon receiving (step 628) the UL control information, the UE 110 may adjust (step 630) its TA to, thereby, achieve UL synchronization. Achieving UL synchronization may be understood to relate to aligning timing with frame structures of UL communications.

Once the UE 110 has achieved DL synchronization (by processing received SSBs) and UL synchronization (by adjusting its TA), the UE 110 may be considered to be ready for receiving DL traffic and/or transmitting UL traffic.

It is anticipated that future wireless communication networks will enable applications with diverse frame structures. In current wireless communication networks, however, it may be shown to be challenging to align frame timing among a plurality of signals with diverse frame structures.

The known paging and synchronization procedure of FIG. 6 illustrates that a paging operation for a group of UEs may involve the BS 170 transmitting (step 606A, step 606B) one or more SSBs in order for UEs in the group to perform DL synchronization on demand. As a result, a paging procedure may be coupled (in time or in beam) with SSB transmissions, which may not be necessary.

As discussed briefly hereinbefore, a UE 110 may lose UL synchronization or a UE 110 may determine that UL synchronization is uncertain. Root causes of the loss or uncertainty may be related to the mobility of the UE 110, may be related to some drifting of time at a clock that is local to the UE 110 or may be related to UE sleep behavior in power saving mode.

It may be shown that the RACH procedure may be initiated (step 622) responsive to the UE 110 determining that UL synchronization has been lost or is uncertain. It may be shown that the RACH procedure may allow for one or more BSs 170 to estimate a TA (or a plurality of TAs) to obtain an accurate TA value or a related propagation delay. The BS 170, upon obtaining an accurate TA value or a related propagation delay, may provide, to the UE 110, the TA value or the related propagation delay to, thereby, assist the UE 110 in achieving UL synchronization.

It may be shown that the known scheme of FIG. 6 may be associated with various limitations. Indeed, the various limitations may be related to the manner in which paging messages are coupled to system information transmissions (such as SSB). It may also be shown that the known scheme of performing DL synchronization and UL synchronization, as illustrated in FIG. 6, may be associated with relatively high signaling overhead. It may be shown that the known scheme of FIG. 6 may be associated with delay and power consumption. The delay and power consumption may be shown to limit some of the applications or services that are suited to future networks. Applications that may be considered to be suited to future networks include latency-critical applications, like ultra-reliable, low-latency communication (URLLC). Future low-cost devices may be expected to employ URLLC.

In overview, aspects of the present application relate to simplifying signaling and reducing latency associated with paging with DL and UL traffic (e.g., control or data) communication. More particularly, aspects of the present application relate to a paging procedure featuring absolute timing indication and/or calibration information. Conveniently, it may be shown that aspects of the present application allow for faster and more accurate DL synchronization and UL synchronization.

A paging procedure may be defined being associated with cell-common, group-common, or UE specific DL signaling. The signaling may be configured to be periodic or aperiodic. The signaling may be used to notify a single UE or a plurality of UEs of events, such as a weather warning or a risk warning. The signaling may be used to notify a single UE or a plurality of UEs of a communication type, such as communication of a type suitable for a sensing operation. The signaling may be used to notify a single UE or a plurality of UEs of paging skipping or paging data. The signaling may be used to notify a single UE or a plurality of UEs of a schedule for time resources and frequency resources to be used for future transmission of a paging message.

A paging message is expected to include a paging UE ID (e.g., a 5G Serving Temporary Mobile Subscriber Identity, “TMSI” or a 5G-S-TMSI mod 1024) for each paged UE. The plurality of UEs may sleep or spend time in an inactive state or an idle state over the course of a DRX cycle and wake-up just before a paging occasion. A given UE may be aware, by configuration, when to expect a paging occasion. As discussed hereinbefore, paging occasions may be configured to occur periodically or aperiodically. A given UE may wake-up just before a paging occasion responsive to an event trigger, such as the arrival of traffic that is to be transmitted in an UL.

It is known that the DRX cycle may apply to UEs in a connected state, in an inactive state or in an idle state and the DRX cycle may apply to UEs in different power saving modes. A given UE may periodically wake up, out of a sleep mode, to monitor for paging messages and then go back to the sleep mode if a received paging message is determined, by the given UE, not to be intended for the given UE.

A DRX cycle may be configured to be cell-based, group-based or even UE-specific. Configuration of a DRX cycle may be communicated, to a UE, for example, by an RRC message or by higher-layer signaling. A default DRX value may be broadcast to a plurality of UEs in system information. The default DRX value may find use in those instances wherein a DRX cycle has not yet been configured.

For each DRX cycle, there are a number of paging frames (PFs). For each PF, there are a number of paging occasions. A PF-offset parameter may be used, by a UE, to determine timing for the PF(s). PF-offset parameters may be configured, in a semi-static manner, using RRC signaling, medium access control layer control element (MAC-CE) signaling or by a higher-layer signaling. Instead of configuring PF-offset parameters in a semi-static manner, some aspects of the present application relate to configuring the PF-offset parameters in a dynamic manner using, e.g., DCI signaling.

To receive a paging message in a paging occasion, a UE may, first, perform DL synchronization and, second, begin monitoring for and, eventually, detecting paging notification signaling (or paging-based DCI) in a PDCCH. This order of operations may be especially relevant for a UE with lost, or uncertain, DL synchronization. Moreover, before a UE is to perform a UL transmission (carrying control or/and data), the UE may attempt to achieve UL synchronization. In particular, the attempt, by the UE, to achieve UL synchronization may be responsive a loss or uncertainty of UL synchronization related to the mobility of the UE 110, related to some drifting of time at a clock that is local to the UE 110 or related to a relatively long sleep over a DRX cycle.

To achieve DL synchronization and/or UL synchronization as well as reduce the overall signaling overhead, the following features are proposed:

Aspects of the present application relate to the BS transmitting a paging-specific reference signal (referenced hereinafter as a “PaRS”). The PaRS may provide a UE with a basis on which to determine DL synchronization. The PaRS may, alternatively or additionally, provide, to the UE, an indication, such as a paging indication or an event indication. Conveniently, use of a PaRS may render unnecessary known SSB transmissions (step 606A, step 606B, FIG. 6). In this way, transmission of SSBs may be decoupled from a paging procedure, for example, when the UE is in a power saving mode such as Inactive or Idle mode or state.

One or more PaRSs may be newly designed. Alternatively, a known reference signal design, such as the design for the channel state information reference signal (CSI-RS), may be used for the design of a PaRS. Another known reference signal design, such as the design for preambles in known networks, may be used for the design of a PaRS.

A PaRS may serve a function as at least one of a primary synchronization signal (PSS), a secondary synchronization signal (SSS), a common CSI-RS or a UE-specific CSI-RS. In some aspects of the present application, the PaRS may be received or detected, at the UE, by a relatively low-cost signal detector. In some aspects of the present application, the PaRS may be received or detected, at the UE, by an analog circuit.

Moreover, a PaRS may provide, to the UE, other indications, such as an early indications regarding presence or absence of an upcoming paging message. For example, the PaRS may be designed/configured in such a way that a UE may interpret a failure to detect a PaRS as an indication that there will be no paging message in the current paging cycle or in a series of paging cycles starting with the current paging cycle.

One PaRS among multiple PaRSs may be used to indicate, to the UE, different events, e.g., a data communication event, a sensing event or both events. A manner of operation responsive to received PaRSs may be configured using RRC signaling or higher-layer signaling.

In some aspects of the present application, multiple beams in, for example, high frequency bands, may be used for the SSBs and different SSBs may, as is usual, be configured and identified by time indices, i.e., time locations related to frames, slots and/or symbols. A BS 170 may employ a manner in which SSB time locations, which may be associated with beamforming directions, have been configured, when transmitting a PaRS. That is, the BS 170 may transmit a PaRS associated with a configured SSB time location or transmission direction. If possible, transmission of SSBs in the configured SSB time location may be curtailed or nulled.

This strategy of the BS 170 using SSB time locations to transmit PaRS may be shown to decouple transmission of PaRS from transmission of SSBs, where decoupling is desired.

As a PaRS may be transmitted, by the BS 170, in time resources that have been configured specifically for the PaRS, where those time resources are closely related to a SSB time location, it may be shown that a UE 110 is able to monitor and detect the PaRS in a beam/transmission direction over which an SSB is expected to be received from the BS 170, even though there is no transmission of the expected SSB.

In scenarios of multiple beam directions, a distinct PaRS may be transmitted in each beam direction of a plurality of beam directions that have been configured for transmission of SSBs. Each beam direction may be associated with a time index or a time location that may be expressed in terms of frames, slots and/or symbols. That is, given the predefined or preconfigured SSB beam directions with time indices (relative to frames, slots and symbols), distinct PaRSs can be transmitted (from the BS 170) in these respective beam directions of the SSBs while using different configured time resources, where the SSBs may not necessarily be transmitted. As a result, on the one hand, the UE 110 may be able to determine a beam direction from the BS 170 upon receiving/detecting a PaRS. On the other hand, the UE 110 may perform UL transmission in a beam direction over which a PaRS has been received with good signal condition. It follows that the beam direction used by the UE 110 may be interpreted, by the BS 170, as indicating a relatively good reception direction. Such a mechanism may be considered to represent a mutually implicit beam direction indication. In other aspects of the present application, the UE 110 may transmit, to the BS 170, explicit signaling (on an SSB time index or on a plurality of SSB time indices) indicative of beam directions that are to be used for DL communications and UL communications.

It may be shown that a step toward achieving UL synchronization involves estimating a propagation delay. Aspects of the present application relate to a one-way measurement strategy. Such a one-way measurement strategy stands in contrast to known propagation delay estimation strategies that involve the UE 110 performing a RACH procedure to obtain, from the BS 170, a TA estimated at the BS 170 (see FIG. 6). Such known propagation delay estimation strategies may be referenced as round-trip, or two-way, measurement strategies. Those aspects of the present application that relate to one-way measurement strategies may be shown to benefit from accurate timing reference information. Indeed, the UE 110 may obtain an estimate for a propagation delay based on a measurement of a time difference between a reception time for a message and a transmission time for the same message. The message may, for example, be a paging message or any other message. It may be shown that, if the accuracy of a given propagation delay estimate is on the order of nanoseconds, then the given propagation delay estimate may be considered sufficiently accurate to serve as a basis for deriving a TA for UL synchronization.

To obtain measurements, in a one-way measurement strategy, with an accuracy that leads to sufficient propagation delay estimate accuracy, it may be shown that a relatively accurate timing reference or a timing calibration value are helpful.

Aspects of the present application relate to a BS 170 providing, to a UE 110, an absolute timing reference or timing calibration can be done before or during the paging procedure. For example, the BS 170 may provide a relatively high-resolution timing reference with a transmission of a paging message during a paging procedure. Alternatively, the UE 110 may be time aligned with a timing reference point before the paging procedure begins. Moreover or further alternatively, a relatively high-resolution timing reference or timing calibration value may be provided, to the UE 110, to, thereby, allow the UE 110 to perform relatively accurate reception time estimation. The relatively high-resolution timing reference or timing calibration value may be used, by the UE 110, to, for example, correct a UE clock time drift.

The task of propagation delay estimation may be represented by the task of determining a difference, tᵣₓ−tₜₓ, between a reception time, tᵣₓ, and a transmission time, tₜₓ.

In known wireless communication networks, applying a one-way measurement strategy to the task of propagation delay estimation may be expected to incur an estimation error of around 1.5 μs. The scale of this estimation error may be considered to be too big to allow such an inaccurate propagation delay estimation to be used for UL synchronization, at least in part due to timing accuracy issues between the BS 170 and the UE 110.

It may be considered that the known UE 110 does not have an ability to determine a suitably accurate transmission time, tₜₓ. Indeed, it may be considered that the known UE 110 is capable of determining a low-resolution transmission time, t_{tx_low}, expressed in terms of a frame boundary, a slot or a symbol. However, it may be shown that the resolution of which the known UE 110 is capable is not suitable to the task of obtaining a sufficiently accurate propagation delay estimate. It may also be considered that the known UE 110 does not have an ability to determine a reception time, tᵣₓ, that is suitably accurate. Indeed, it may be considered that the known UE 110 may be subject to local clock inaccuracies, such as those inaccuracies that occur due to local clock time drifting or timing/synchronization error accumulation.

It is proposed herein that, to achieve sufficiently accurate propagation delay estimation while carrying out a one-way measurement strategy, an accurate timing reference would be helpful. It is further proposed herein that, to achieve sufficiently accurate propagation delay estimation while applying a one-way measurement strategy, it would be helpful to have a timing calibration value with a relatively high resolution or a relatively small granularity for both the transmission time, tₜₓ, and the reception time, tᵣₓ. Relatively small granularity may be defined as granularity at the nanoseconds level.

According to aspects of the present application, the UE 110 may perform DL propagation delay estimation while executing a one-way measurement strategy, based upon obtaining reference timing information for the transmission time, tₜₓ. It is considered that there are multiple ways in which the UE may accomplish such reference timing information obtaining.

For one example, the UE 110 may find that reference timing information for the transmission time, tₜₓ, is carried in a received paging message.

For another example, the UE 110 may, before a paging occasion, take steps to achieve time-alignment with the BS 170. The UE 110 may achieve such time-alignment in terms of a standard timing reference point. The UE 110 may obtain the standard timing reference point by processing received GPS signals. Alternatively, the standard timing reference may be a timing reference point at the BS 170.

For a further example, the UE 110 may be provided with reference timing information for the transmission time, tₜₓ, as a BS-side reference frame boundary. The reference frame boundary may, for three examples, be expressed as a frame boundary, a slot boundary or a symbol boundary. For example, when the UE 110 obtains a transmission time, tₜₓ, for a given symbol, the transmission time may be expressed relative to a BS-side reference frame boundary, e.g., the transmission time from the BS-side in downlink is based on a frame, a slot in a frame or a symbol in a slot, usually indicated by the scheduling message, DCI signaling or pre-configured signaling, such as RRC.

At the reception side, it is preferred that the UE 110 be capable of obtaining the reception time, tᵣₓ, with an accuracy that is similar to the accuracy with which the UE 110 is able to obtain the transmission time, tₜₓ.

It has been discussed, hereinbefore, that the known UE 110 may be subject to local clock inaccuracies, such as those inaccuracies that occur due to time drifting or timing/synchronization error accumulation. Aspects of the present application may be shown to act to counter the local clock inaccuracies through a calibration procedure or through a time-realignment procedure carried out in conjunction with the BS 170.

The calibration procedure may be accomplished by the UE 110 processing a (time) reference to a frame boundary, such as a frame boundary, a slot boundary or a symbol boundary, in the context of a standard timing reference point. The UE 110 may obtain the standard timing reference point by processing received GPS signals. Accordingly, the BS 170 may transmit, to the UE 110, calibration information in the form of the standard timing reference point associated with a frame boundary. The BS 170 may transmit the calibration information to the UE in a message, for example, a DL control message or a DL data message. The message may, e.g., be carried by a paging message, by paging notification signaling (DCI), by a PaRS, by an SSB, by UE-specific signaling or by piggybacking the message in DL data.

The calibration may be accomplished, before a paging occasion, by the UE 110 performing a time alignment operation in conjunction with the BS 170 in the context of a standard timing reference point. The UE may obtain the standard timing reference point by processing received GPS signals.

The calibration may be accomplished, before a paging occasion, by the UE 110 performing a time alignment operation in conjunction with the BS 170 in the context of a timing reference point at the BS 170.

For example, before the UE 110 goes to sleep in a DRX cycle, the UE 110 may request a time-realignment with the BS 170.

Note that, for the UL direction, a one-way measurement strategy applied to propagation delay estimation is similar to the example described above for the DL direction. In some scenarios, the UE 110 may time-realign with the BS 170 either by transmitting a request for a (new) time realignment procedure or by sending, to the BS 170, information indicative of a current UE frame boundary (e.g., frame number, slot number and/or symbol number) and associated UE timing information. Upon receipt of this information, the BS 170 is expected to be able to determine a timing difference between the frame boundary of the UE 110 and the frame boundary of the BS 170. Upon determining the timing difference, the BS 170 may be lead to knowledge of a relatively accurate transmission time from the UE 110. In some aspects of the present application, the UE 110 may use a control channel (e.g., a UE-specific UL control channel, PUCCH, etc.) to transmit, to the BS 170, a request for a (new) time realignment procedure or information indicative of a current UE frame boundary. In some aspects of the present application, the UE 110 may use a data channel (e.g., a MAC-CE, piggybacked with UL data, short data transmission in inactive state or in idle state, grant-free transmission) to transmit, to the BS 170, a request for a (new) time realignment procedure or information indicative of a current UE frame boundary.

It is known that DL synchronization is especially useful in the context of CFO compensation, AGC, time tracking and frequency tracking. Aspects of the present application relate to methods for a UE 110 to achieve DL synchronization based on reception of PaRS.

In some aspects of the present application, the PaRS is separate from PDCCHs.

In some other aspects of the present application, the PaRS forms an integral part of a PDCCH. In particular, the PaRS may be part of paging notification signaling within the PDCCH. Alternatively, the PaRS may be part of a demodulation reference signal (DMRS) within a PDCCH.

In a manner that may be compared to a preamble for UL transmissions, the PaRS may provide a basis for the UE 110 to achieve relatively accurate and relatively robust DL synchronization by detecting the preamble-like signal of the PaRS transmitted from a base station or from another network entity. The PaRS may also provide a basis for the UE 110 to perform channel estimation for the PDCCH and the PDSCH. The PaRS may also provide a basis for the UE 110 to perform paging message decoding. The PaRS may also provide other indications, such as an early paging indication on paging present or not (e.g., if not paging for this group, no PaRS is present).

Conveniently, when DL synchronization is achieved on the basis of PaRS, it follows that DL synchronization need not be achieved on the basis of one or more SSBs. Accordingly, a frequency of SSB transmissions may be reduced. Furthermore, when DL synchronization is achieved on the basis of PaRS, DL synchronization may be achieved before a given paging occasion. Additionally, a UE may base beam identification on processing of received PaRS.

Aspects of the present application relate to UL synchronization to align, at a BS 170, frames of UL transmission.

The UL synchronization may, for example, involve one-way propagation delay estimation, in which paging notification signaling or a paging message may provide an absolute timing reference, a relatively accurate timing reference or a high-resolution time indication for the transmission time, tₜₓ. The paging notification signaling or the paging message may additionally or alternatively provide a calibration value associated with the reception time, tᵣₓ.

It may be shown that the proposed one-way measurement (DL measurement only) strategy is capable of being used to achieve UL synchronization. Indeed, the proposed strategy may be shown to allow for estimation of a difference, tᵣₓ−tₜₓ, between a reception time, tᵣₓ, and a transmission time, tₜₓ, that is accurate to about 10 nanoseconds with a high-resolution timing reference.

Rather than receiving a TA from the BS 170, the UE 110 may directly estimate a TA based on the estimated difference, tᵣₓ−tₜₓ. Accordingly, by starting a UL transmission a timing advanced by duration equivalent to the estimated difference, tᵣₓ−tₜₓ, the UE 110 may be seen to compensate for the propagation delay between the UE 110 and the BS 170. Indeed, given calibrated UE and BS timing, a one-way propagation delay measurement may be carried out at any time, on demand, by the UE 110 using any DL transmission (for data or for control). By performing TA maintenance, the UE 110 may maintain the validity of the UL synchronization as long as DL synchronization is also maintained. It may be shown that the one-way measurement strategy may be carried out readily and straightforwardly while the frame boundaries of both the UE 110 and the BS 170 are aligned in time within a relatively small granularity (e.g., around 10 nanoseconds).

Given this one-way (e.g., DL) measurement, the UE may be shown to be able to obtain relatively quick UL synchronization, which may be shown to support configured grant short data transmission (CG-SDT) and mobile terminated SDT (MT-SDT) for the UE 110 in an Inactive state or in an Idle state. In this case, a timer that is known to be used, in NR, to limit UL SDT can be removed. It may be understood that the known NR timer has been established due to UL synchronization concern.

It may be shown that aspects of the present application significantly reduce, relative to known schemes, the number of steps and the signaling overhead.

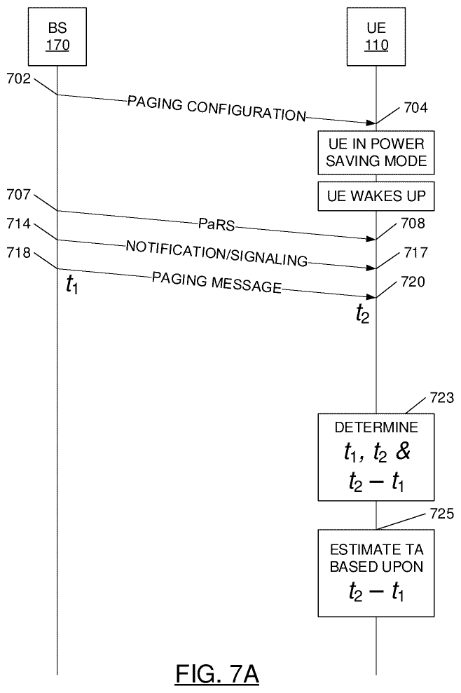

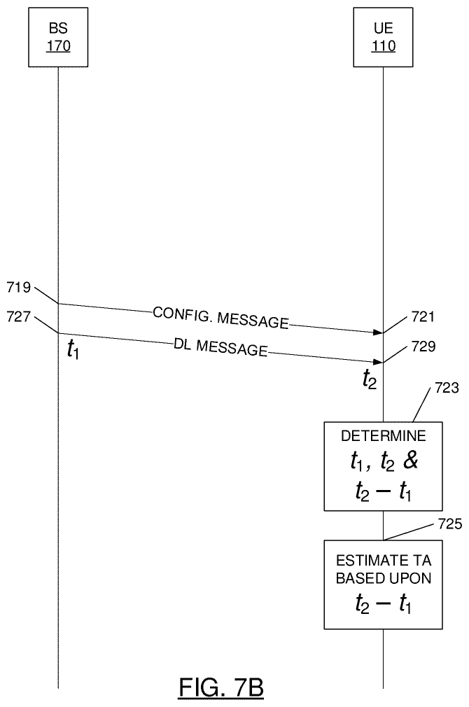

FIG. 7A illustrates, in a traffic flow diagram, procedures that may be carried out by an example BS 170 and an example UE 110 that may be understood to be in power mode that includes a sleep cycle or a DRX cycle. In FIG. 7A, it may be understood that the UE has lost DL and/or UL synchronization with the BS 170.

The BS 170 initially transmits (step 702) a paging configuration message. Transmission (step 702) of the paging configuration message may, for example, be implemented using RRC signaling or using DCI signaling. The paging configuration may include indications of parameters related to paging. The parameters related to paging may include PaRS parameters. The parameters related to paging may include a time offset between a (last) PaRS and a (first) paging opportunity in the paging frame. The transmission (step 702) of the paging configuration may be carried out using a SSB in combination with system information. Alternatively or additionally, the transmission (step 702) of the paging configuration may be carried out using a higher-layer signaling, such as RRC.

Subsequent to receiving (step 704) the paging configuration and at certain point before a paging occasion, the UE 110 may enter a power saving mode. The power saving mode may, for example, be implemented, by the UE 110, as a sleep portion of a DRX cycle. The UE 110 may be understood to have some UL data to transmit. With regard to the paging configuration, the UE 110 wakes up.

Upon waking, the UE 110 may monitor for PaRSs. Responsive to the BS 170 transmitting (step 707) a PaRS, the UE 110 may detect (step 708) the PaRS. The PaRS may be understood to accommodate DL synchronization for a paging group of UEs to which the UE 110 belongs.

The BS 170 may transmit (step 714) a paging (or DL) notification or paging control signaling, such as group-common or UE-specific downlink control information (DCI) signaling. The BS 170 may transmit (step 714) the paging (or DL) notification or paging control signaling in a DL control channel, such as physical downlink control channel (PDCCH). The paging (or DL) notification may comprise one or more notifications of events, such as a weather warning, a risk warning, a future DL data transmission, a paging occasion or paging frame skipping.

The UE 110 may determine that the paging notification includes a schedule that specifies time resources and frequency resources for transmission, by the BS 170, of a future paging message.

The UE 110 may determine that the DL notification includes a schedule that specifies time resources and frequency resources for transmission, by the BS 170, of a future DL data transmission.

The BS 170 may next transmit (step 718) a paging message at a transmission time identified, in FIG. 7A, as t₁. Based on the paging notification, or other signaling, received in step 717, the UE 110 may monitor for the paging message. In particular, the UE 110 may monitor a DL data channel, such as the known physical downlink shared channel (PDSCH). The paging message may include a paging UE ID for each paged UE. The paging message may also include a relatively high-resolution timing indication specifying the transmission time, t₁. The paging message may include a calibration value associated with allowing the UE 110 to determine a reception time identified, in FIG. 7A, as t₂. The paging message may, accordingly, be understood to support relatively accurate one-way propagation delay measurement. That is, the UE 110 may determine (step 723), t₁, t₂ and a difference (t₂−t₁) between the reception time and the transmission time, i.e., a one-way propagation delay. The UE 110 may then estimate (step 725) a UL transmission time advance (TA) based upon the difference.

The scheme, illustrated in FIG. 7A, that involves performing the one-way propagation delay measurement in the paging procedure, which scheme may be considered suitable for the scenario in which the UE 110 is in a power saving mode (e.g., an inactive mode or an idle mode), may be extended to more general scenarios, i.e., for the scenarios in which the UE 110 is in a power saving mode (e.g., an inactive mode or an idle mode) and for the scenarios in which the UE 110 is in a connected mode, where UE 110 is active with continuous transmission or reception. In a scheme extended to more general scenarios, illustrated in a traffic flow diagram in FIG. 7B, the BS 170 may indicate or calibrate a transmission or reception time by a configuration message or a DL data/control transmission. Indeed, FIG. 7B illustrates that the BS 170 may transmit (step 719) a configuration message. The configuration message may be implemented in DL signaling as at least one of RRC signaling, DCI signaling, paging notification (e.g., in a power saving mode) and other DL control signaling (e.g., group-common signaling or UE-specific signaling). The BS 170 may next transmit (step 727) a DL message, which, for example, is a data or control transmission that can be scheduled by the configuration message or another configuration signaling.

The configuration message, received (step 721) by the UE 110, may include a relatively accurate indication, or time calibration, of the transmission time, t₁, that is, the planned time of transmission (step 727) of the DL message. The DL message is received (step 729) by the UE 110 at a reception time, t₂. The configuration message, received (step 721) by the UE 110, may include a calibration value that allows the UE 110 to realign a reception time boundary (e.g., a frame boundary, a slot boundary or a symbol boundary) such that the UE 110 may more accurately determine (step 723) an estimate for the reception time, t₂, of the DL message.

For reception calibration, the DL message, transmitted (step 727) by the BS 170, may include an indication of a calibration value or other calibration information. The DL message may be a data transmission or a control message. For the case wherein the DL message is a data transmission, the indication of a calibration value or other calibration information may be multiplexed with the data. For the case wherein the DL message is a control message, the DL message may be implemented in DL signaling as at least one of RRC signaling, DCI signaling, paging notification and other DL control signaling (e.g., group-common signaling or UE-specific signaling). Upon receipt (step 729) of the DL message including the calibration value, the calibration value may be shown to allow the UE 110 to obtain a relatively accurate value for the reception time, t₂. For the case wherein the DL message is a control message, the DL message may be combined with the configuration message transmitted in step 719. In this case, one message is sufficient to allow the UE 110 to obtain a relatively accurate transmission time, t₁, and a relatively accurate reception time, t₂.

In view of implementing the TA, the UE 110 may be considered to have achieved DL synchronization and UL synchronization. Accordingly, the UE 110 may be considered to be ready for DL traffic transmissions and/or UL traffic transmissions. It may be shown that the scheme illustrated in FIG. 7A represents a significant reduction in steps for a paging procedure and signaling overhead as compared the scheme illustrated in FIG. 6, which scheme is known to be used in current NR network.

Aspects of the present application relate to the relatively accurate timing reference and timing calibration that is performed in reference to a timing reference point. The timing reference point may be a reference time instant or an absolute time reference in the network or cell. Conveniently, the timing reference point may have relatively higher timing accuracy, such as with a granularity of 10 nanoseconds or smaller.

Alternatively, the UE 110 may be subject to a time-realignment process involving the BS 170 in view of a timing reference point. The timing reference point may, for one example, be based at the BS 170. The timing reference point may, for another example, be based on received GPS signaling. The time realignment process may be initiated by the BS 170 or initiated by the UE 110. After the time-realignment process has been carried out, it is expected that the timing of the frame boundaries, for both the BS 170 and the UE 110, is sufficiently accurate. The term frame boundary may be understood to refer, for example, to a boundary of a frame, a boundary of a slot or a boundary of a symbol. The term “sufficiently accurate” may be considered to an accuracy specified for the determination of the one-way measurement preference, e.g., a granularity of about 10 nanoseconds.

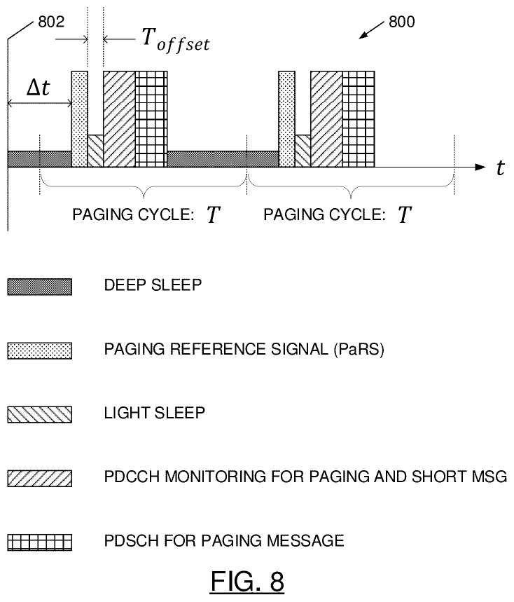

FIG. 8 illustrates a timeline 800 of activity for the UE 110. The timeline 800 of FIG. 8 begins at a timing reference point 802. FIG. 8 illustrates that the UE 110 may commence receiving a PaRS at a relative time, At, that may be understood to have been expressed with reference to the timing reference point 802. FIG. 8 illustrates that a configured paging occasion, wherein the UE 110 may commence monitoring PDCCH for paging and short messages, begins at a time that is an offset, T_{offset}, following the PaRS. For those situations wherein the timing reference point has been configured or wherein a time-realignment process has been carried out by the BS 170 in combination with the UE 110, it may be shown that a value for the offset, T_{offset}, may be configured semi-statically (e.g., by RRC, MAC-CE) or/and may be indicated dynamically (e.g., by DCI).

The relatively accurate reference timing indication and calibration (alternatively referred to as absolute timing indication or calibration) using the timing reference point 802 may be carried by the paging notification signaling (transmitted in step 714, FIG. 7A) or carried by the paging message (transmitted in step 718, FIG. 7A). In some aspects of the present application, the timing calibration may be provided in such a way that clock time drifting or synchronization error accumulation can be corrected for the BS 170 and/or for the UE 110.

As illustrated in FIG. 8, the UE 110 may wake up at the relative time, At, after the timing reference point 802 to monitor for one or more PaRSs before the configured paging occasion. The (first) paging occasion in a paging cycle may be configured to occur the offset, T_{offset}, following the (last) PaRS time location. Upon having detected one or more PaRSs, the UE 110 may monitor and detect paging notification signaling (e.g., paging DCI). Upon having received paging notification signaling indicating that the UE 110 is to expect a future paging message, the UE 110 may monitor and detect for paging messages in a data channel, such as a PDSCH. However, if no PaRS is detected, the UE 110 may assume that there are to be no paging occasions, at least for the current paging cycle. As illustrated in FIG. 8, the paging cycle has a period, T.

In some conditions or situations, related to channels, environment or mobility, a PaRS signal can be missed. Upon determining that there have been a consecutive number of PaRS detection failures exceeding a threshold, the UE 110 may resort to using SSB for DL synchronization or cell reselection. The threshold number of consecutive PaRS detection failures may be expressed as “N,” where N>0 and N is configurable by, e.g., RRC signaling.

As illustrated in FIG. 8, the UE 110 may have a deep sleep (defined, e.g., based on consuming minimum power) before waking up to detect PaRSs. As further illustrated in FIG. 8, the UE 110 may have a light sleep (defined, e.g., based on a power consumption that is higher than the deep sleep but that is lower than normal transmissions or receptions).

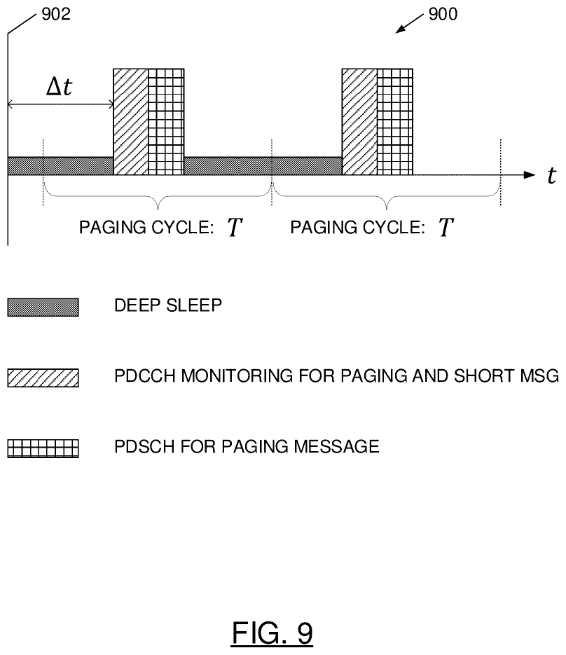

FIG. 9 illustrates a timeline 900 of activity for the UE 110. The timeline 900 of FIG. 9 begins at a timing reference point 902. FIG. 9 illustrates that the UE 110 may commence detecting paging at a relative time, At, that may be understood to have been expressed with reference to the timing reference point 902 while DL synchronization is still valid.

FIG. 9 illustrates that the UE 110 may determine not to detect a PaRS, where the timing reference point 902 is a reference time instant or absolute time reference (with relatively higher timing accuracy, such as a granularity of 10 nanoseconds or smaller) in the network or cell.

In the scenario illustrated in FIG. 9, the UE 110 may have a paging cycle with a deep sleep and with, e.g., a period, T. The UE 110 may wake up just before a paging occasion and commence monitoring for paging messages and short messages. After receiving a paging message and determining, from the paging message, that no DL data or UL data is intended for the UE 110, the UE 110 may go back to the deep sleep until the next paging occasion.

For those situations wherein the timing reference point 902 has been configured or wherein a time-realignment process has been carried out by the BS 170 in combination with the UE 110, it may be shown that the wake-up time location (relative time, At) may be configured semi-statically (e.g., by RRC signaling, MAC-CE signaling) or/and indicated dynamically (e.g., by DCI).

Aspects of the present application relate to one or more PaRSs or a set of PaRSs being used to indicate one or more events on top of the use of PaRSs for DL synchronization.

The PaRSs may, for example, indicate a system information (SI) change. Responsive to such an SI change indication, the UE 110 may check/detect subsequent SSBs to update the SI parameters.

The PaRSs may, for example, indicate paging occasions for different groups of UEs 110, where one PF may include a plurality of paging occasions. The plurality of paging occasions may include one paging occasion for each sub-group of UEs 110 among a plurality of sub-groups of UEs 110.

The PaRSs may, for example, indicate specific paging occasions related to traffic/operation types. The traffic/operation type may be understood to include sensing traffic/operation types, data communication traffic/operation types or traffic/operation types that are related to sensing and data communication.

Notably, the absence of PaRS may also convey information. A UE 110 may interpret the absence of PaRS as an indication that no paging messages are to be expected in the current paging cycle. A UE 110 may interpret the absence of PaRS as an indication that the UE 110 may skip a configurable number (N) of paging cycles for paging monitoring.

The various indications discussed as being carried by the PaRS may be configured semi-statically (e.g., by RRC signaling, MAC-CE signaling) or/and indicated dynamically (e.g., by DCI).

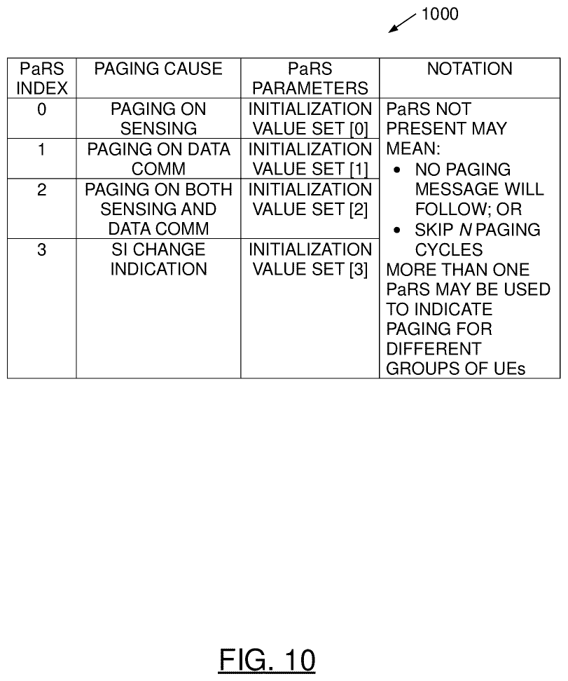

FIG. 10 illustrates a table 1000 summarizing configuration of the various indications discussed as being carried by the PaRS. In particular, the table 1000 of FIG. 10 provides four PaRS indices, (0,1,2,3). The range of indices illustrated in the table 1000 of FIG. 10 is based on using two bits to represent the PaRS index.

The table 1000 of FIG. 10 includes a column for PaRS parameters. Each PaRS may be implemented as a Zadoff-Chu (ZC) sequence and may be configured based on an initialization value set, [i], i=0,1,2,3. The UE 110 may receive an indication of the parameters in each initialization value set, e.g., by RRC signaling. Each initialization value set, [i], may include sequence generation parameters. Known sequence generation parameters for ZC sequences include a cyclically shifted version, a sequence length, etc.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
receiving, at a reception time, a downlink message; and
transmitting an uplink signal with an uplink signal timing, the uplink signal timing based on a difference between the reception time and a transmission time determined for the downlink message.

2. The method of claim 1, further comprising:
receiving a first configuration message, wherein first configuration message includes an indication of the transmission time; or
the downlink message comprises an indication of the transmission time.

3. The method of claim 2, wherein the indication of the transmission time is based on a reference timing source.

4. The method of claim 1, wherein:
the method further comprises receiving a first configuration message comprising a calibration value associated with the transmission time; or
the downlink message comprises the calibration value associated with the transmission time.

5. The method of claim 4, wherein the calibration value is based on a reference timing source.

6. The method of claim 5, further comprising:
receiving a second configuration message, the second configuration message including parameters for a reference signal;
receiving, based on the parameters, the reference signal; and
deriving the reference timing source from the reference signal.

7. The method of claim 1, wherein the uplink signal timing is based upon a timing advance, the timing advance is obtained based upon a propagation delay estimation, and the propagation delay estimation is based on the difference between the reception time and the transmission time of the downlink message.

8. An apparatus comprising:
at least one processor coupled to a memory storing computer-readable instructions, wherein, by executing the computer-readable instructions, the apparatus is caused to:
receive, at a reception time, a downlink message; and
transmit an uplink signal with an uplink signal timing, the uplink signal timing being based on a difference between the reception time and a transmission time determined for the downlink message.

9. The apparatus of claim 8, wherein:
by executing the computer-readable instructions, the apparatus is further caused to receive a first configuration message, wherein first configuration message includes an indication of the transmission time; or
the downlink message comprises an indication of the transmission time.

10. The apparatus of claim 9, wherein the indication of the transmission time is based on a reference timing source.

11. The apparatus of claim 8, wherein:
by executing the computer-readable instructions, the apparatus is further caused to receive a first configuration message comprising a calibration value associated with the transmission time; or
the downlink message comprises the calibration value associated with the transmission time.

12. The apparatus of claim 11, wherein the calibration value is based on a reference timing source.

13. The apparatus of claim 12, wherein by executing the computer-readable instructions, the apparatus is further caused to:
receive a second configuration message, the second configuration message including parameters for a reference signal;
receive, based on the parameters, the reference signal; and
derive the reference timing source from the reference signal.

14. The apparatus of claim 8, wherein the uplink signal timing is based upon a timing advance, the timing advance is obtained based upon a propagation delay estimation, and the propagation delay estimation based on the difference between the reception time and the transmission time of the downlink message.

15. A non-transitory computer-readable medium storing instructions, wherein the instructions, when executed by at least one processor, cause an apparatus to be enabled to:
receive, at a reception time, a downlink message; and
transmit an uplink signal with an uplink signal timing, the uplink signal timing being based on a difference between the reception time and a transmission time determined for the downlink message.

16. The non-transitory computer-readable medium of claim 15, wherein:
the instructions, when executed by the at least one processor, further cause the apparatus to be enabled to: receive a first configuration message, wherein the first configuration message includes an indication of the transmission time; or
the downlink message comprises an indication of the transmission time.

17. The non-transitory computer-readable medium of claim 16, wherein the indication of the transmission time is based on a reference timing source.

18. The non-transitory computer-readable medium of claim 15, wherein:
the instructions, when executed by the at least one processor, further cause the apparatus to be enabled to: receive a first configuration message comprising a calibration value associated with the transmission time; or
the downlink message comprises the calibration value associated with the transmission time.

19. The non-transitory computer-readable medium of claim 18, wherein the calibration value is based on a reference timing source.

20. The non-transitory computer-readable medium of claim 15, wherein the uplink signal timing is based upon a timing advance, the timing advance is obtained based upon a propagation delay estimation, and the propagation delay estimation is based on the difference between the reception time and the transmission time of the downlink message.
